(19) United States
(12) Patent Application Publication
(10) Pub. No.: US 2011/0061622 A1
(43) Pub. Date: Mar. 17, 2011

(54) FUEL COMPOSITION

(76) Inventor: Morten A. Lund, Vista, CA (US)

(21) Appl. No.: 12/993,455

(22) PCT Filed: May 22, 2009
(86) PCT No.: PCT/US09/03188

§ 371 Date: Nov. 18, 2010

Related U.S. Application Data
(60) Provisional application No. 61/055,965, filed on May 23, 2008.
(60) Provisional application No. 61/057,199, filed on May 29, 2008.
(60) Provisional application No. 61/214,307, filed on Apr. 22, 2009.

(51) Int. Cl. F02B 13/00; F02M 21/02

(52) U.S. Cl. 123/1 A; 123/525

(57) ABSTRACT

A fuel composition for use in an internal combustion engine comprising at least one liquid fuel and at least one gaseous fuel, the gaseous fuel having an effective solubility in the liquid fuel at twenty degrees Celsius and one atmosphere in the range of 0.0000001 g/kg to 0.0002 g/kg, wherein dispersion of the gaseous fuel within the liquid fuel before introduction of the fuel composition to the injection system of the engine is such that molecules of the liquid and gaseous fuels are substantially equidistant one from another, liquid from liquid and gas from gas, within a variance preferably of no more than one hundred percent (±100%), more preferably of no more than fifty percent (±50%), and most preferably of no more than twenty-five percent (±25%), whereby the fuel composition is substantially homogeneous so as to promote the atomization of the liquid fuel and thus improve combustion.

### RELATED APPLICATIONS

This application claims priority to and is entitled to the filing dates of U.S. Provisional application Ser. Nos. 61/055,965 filed May 23, 2008, and 61/057,199 filed May 29, 2008, both entitled “Multi-Fuel Co-Injection System and Method of Use,” and U.S. Provisional application Ser. No. 61/214,307 filed Apr. 22, 2009, and entitled “Fuel Composition.” The contents of the aforementioned applications are incorporated herein by reference. Accordingly, it is to be understood that any of the embodiments or features disclosed in the incorporated applications or their equivalents may be substituted for or employed in connection with those exemplary embodiments disclosed in the present application, in whole or in part, without departing from the spirit or scope of the invention.

### INCORPORATION BY REFERENCE

Applicant hereby incorporates herein by reference any and all U.S. patents and U.S. patent applications and related international patent applications cited or referred to in this application, including but not limited to: the above-mentioned U.S. Provisional applications to which a priority claim has been made; International patent application Ser. No. PCT/US2006/045399 filed on Nov. 24, 2006, and entitled “A Multi Fuel Co Injection System for Internal Combustion and Turbine Engines”; and the U.S. Provisional patent application to which the above-referenced PCT application claims priority, namely, U.S. Provisional application Ser. No. 60/739,594 filed Nov. 26, 2005, and entitled “Gaseous Enhanced Fuel System for Combustion Engines.”

### TECHNICAL FIELD

Aspects of this invention relate generally to fuels, and more particularly to liquid-gaseous fuel compositions.

### BACKGROUND ART

By way of background, efforts over the past several decades abound directed to various means by which the efficiency of internal combustion engines may be improved. Some of these efforts have focused on the actual engine design, and particularly the fuel delivery, injection, and combustion systems and processes, while other efforts have been directed to improvements to the fuels themselves to somehow increase their combustion effect or the efficiency and uniformity with which they burn, and hence the power derived thereby and/or the degree to which unwanted emissions are reduced. The present application is primarily concerned with the latter category of improvements to the fuel itself, there being presented herein a number of new and improved fuel compositions, the benefits of which will be readily apparent.

As to the prior art, in sum, all known recent efforts to increase the efficiency of internal combustion engines have led to marginal success at best. Most such “improvements” have resulted in only a slight increase in actual efficiency and/or were achieved using approaches that are technologically or practically not workable, as either involving fuels that are not readily available or safely used or systems and hardware that add tremendous cost and complexity to the engine. As an example, in the diesel engine context, much effort has been centered around the hardware necessary to allow higher and higher injection pressures, currently on the order of 25,000 psi and greater, with smaller and smaller nozzle diameters (or injector orifices), currently on the order of ten thousandths of an inch (0.010″), in an attempt to reduce the fuel droplet size and thereby improve the combustion or atomization of the diesel fuel. It will be appreciated that in general such an approach would lead to a finer and finer spray of diesel fuel into the combustion chamber, but such a mechanical approach can only be taken so far and not without a tremendous price in the form of increased manufacturing and operational costs for fuel supply systems and injectors that meet these pressure and tolerance requirements. See, for example, U.S. Patent Application Publication No. US 2008/0173731 to Ismailov, “Background of the Invention,” for a summary of such prior approaches. Ismailov himself teaches a fuel system wherein at least two fuel jets with different jet parameters are positioned within the injector assembly such that the jets interact with each other proximate to the outlets along a surface interface therebetween so as to generate a fine spray within the combustion chamber, allegedly reducing the jet breakup time and fuel droplet size. But by doing these and other things with the geometry of the injector nozzle, piston head, and combustion chamber and even swirling the diesel fuel with air from the intake, the cost and complexity of the resulting engine and fuel system have not been significantly reduced, if at all, and the fuel droplets are still ultimately only being affected mechanically from the outside and not from the inside so as to promote a more complete atomization and burn. What is still needed is a new fuel composition that meets the efficiency and emissions requirements of the industry without the added cost and complexity and relative ineffectiveness of such prior art approaches.

Focusing on the gasoline engine context, and as a further example of how known recent efforts to increase the efficiency of internal combustion engines have led to only marginal success at best, currently much work is being done in the art in connection with homogeneous charge compression ignition (“HCCI”). In ideal “laboratory-type” usage, efficiency gains on the order of thirty percent (30%) are being seen in gasoline internal combustion engines using HCCI, or basically just barely getting gasoline engines to the efficiencies already seen with conventional diesel engines. Moreover, due to the sensitive nature of this approach to combustion and its requirement of precise temperature and pressure conditions (compression ratios) in the combustion chambers for the automatic combustion reaction of the fuel to be set off, under actual road testing where an engine is subjected to various load demands, the HCCI process breaks down, leading not only to little to no efficiency gains but in some cases to engine failures (predetonation).

Other attempts to improve the efficiency and/or reduce emissions of internal combustion engines relating to the fuel itself have included fuel fractioning, additives in the air intake or at the point of injection, which thus don't interact with the fuel until they meet in the combustion chamber, and actual fuel additives incorporated in formulations produced either “on board” or “off board” that for a variety of reasons are yet relatively ineffective or simply yield a fuel that may have improved additive acceptance, stability and storability, and perhaps some improvement in emissions or combustion efficiency, but not both to any appreciable degree as in the fuel composition of the present invention.

First, as to the prior art fuel fractioning approach, generally, a number of references teach on-board fractioning, or separating a fuel into light and heavy distillates, for example, or otherwise conditioning a fuel for varied use depending on the demands of the engine, such as at start-up versus idle versus high RPM's, high or low load, or “warmed” operation. U.S. Pat. No. 2,758,579 to Pinotti and U.S. Pat. No. 2,865,345 to Hilton, commonly assigned and dating to the 1950's, teach systems wherein a liquid residual fuel and a liquid distillate fuel are proportionately mixed and delivered through mechanical metering to the engine. Both Pinotti and Hilton involve residual and/or distillate fuel heaters to adjust through heat the viscosity of one or more of the fuel fractions to facilitate processing of the fuel mixtures, particularly during cold starting.

More recently, U.S. Pat. No. 6,067,969 to Kemmler et al. teaches a fuel supply system for an internal combustion engine that includes an evaporating and condensing device for producing high- and low-boiling fuel components. Kemmler states that “[u]sing shuttle valve 3 and reversing valve 6, it can be ensured that the engine is supplied with the best possible fuel components for optimum operation by selectively feeding it with fuel, i.e., original fuel, low-boiling fuel from condensate line 15, or high-octane residual fuel from residual fuel line 22.”

Similarly, U.S. Pat. Nos. 6,571,748 and 6,622,664 to Holder et al. teach a fuel fractioning system as part of a fuel supply system for an internal combustion engine including a fuel-fractionating device, which is preferably in the form of an evaporator or evaporation chamber that produces at least one fuel fraction from the fuel, preferably both a high and a low boiling point fraction, and an accumulator that receives each fuel fraction from the fuel-fractionating device, stores it, and makes it available to the internal combustion engine, the fuel and fuel fraction(s) being fed to the internal combustion engine by the fuel supply system as a function of demand. In a further embodiment, the fuel and the fraction(s) are mixed in a mixing chamber according to a performance graph stored in a control unit depending on the operating state of the engine and the mixture is then supplied to the engine in a controlled manner. Holder thus discloses a fuel system that splits a liquid fuel into at least two fractions on board, such as a relatively high and relatively low boiling point fraction as through vacuum evaporation, which fractions are then mixed in a manner or ratio that “is optimal for the momentary engine operating state,” such that a dynamic or continuously variable fuel mix is required in the invention, much like Kemmler in this respect. Holder further teaches that a gaseous fluid or fuel fraction (i.e., vapor) may be introduced into the liquid fuel in the form of small bubbles during the fractionating of the fuel “to improve the efficiency of the fractionating process,” Holder specifically stating that “[t]he gas bubbles rising in the fuel are suitable in a special manner for dissolving further low-boiling fuel proportions out of the fuel.” Thus, Holder teaches that the gaseous fuel fraction is not only temporarily so, condensing again within the condensation chamber, but also that it is not to be dissolved in the liquid fuel and is instead to further separate or dissolve out other low-boiling fuel fractions. Holder's primary objective appears to be emissions control.

And even more recently in connection with fuel fractioning systems and fractioned fuels, U.S. Pat. Nos. 7,028,672 and 7,055,511 to Glenz et al. teach a fuel supply system for an internal combustion engine having two separate storage containers for liquid fuels. Specifically, the Glenz systems are directed to delivering alternating liquid fuels to one injector of the engine at a time as derived from a fuel fractionation unit and pushed into the injectors as by compressed air or other gas, which is a similar approach to the well-known original Rudolph Diesel injection practice. Like Holder, the focus of Glenz is also emissions reduction, with specific emphasis on the start-up or warm-up phases of engine operation, and particularly on the on-board mixing and controlled use of optimized “starting” and “main” fuel mixtures as produced by the fuel fractionation unit.

Regarding prior art fuel fractioning systems and resulting fuels, then, it will be appreciated that there is taught only liquid fuel or fuel fraction co-mixtures that are then introduced to the engine's fuel injection system typically in a controlled, variable manner to adjust to the demands of the engine while still reducing emissions, such as when cold starting and the like, without any teaching or suggestion that co-mixtures of liquid and gaseous fuels would be sufficiently mixed and maintained in such a substantially homogeneous state of mixture until being delivered to the engine's fuel injection system for better atomization of the fuel mixture upon injection and thus more efficient combustion.

Turning to the introduction of a fuel additive such as propane or hydrogen through the air intake rather than in the fuel stream, there are known in the art a number of approaches whereby such an additive enters the combustion chamber as part of the air flow. For example, U.S. Pat. No. 7,019,626 to Funk teaches systems, methods and apparatuses of converting an engine into a multi-fuel engine in which some of the combusted gasoline or diesel fuel is replaced in the combustion chamber by the presence of a second fuel such as natural gas, propane, or hydrogen introduced through the air intake or separately directly into the combustion chamber. The Funk system includes a control unit for metering the second fuel and a passenger compartment indicator that indicates how much second fuel is being combusted relative to the diesel or gasoline. It is disclosed that on the order of seventy percent (70%) of the diesel fuel or gasoline is replaced with an alternative second fuel such as natural gas, propane or hydrogen, which is added to the fuel in a maximum amount at roughly seventy percent (70%) throttle opening. Funk indicates that the purpose of the invention is to address the emissions shortcomings of diesel engines and states that the various embodiments disclosed reduce particulate emissions while providing “an inexpensive diesel or gasoline engine conversion method and apparatus that informs the operator of the amount of alternative fuel that is being combusted.”

In Korean Patent Application Publication No. KR 2004/015645A, Bai teaches that liquid fuel and gaseous fuels such as oxygen and hydrogen are mixed and then immediately passed into the combustion chamber through the air intake. Specifically, Bai discloses a jet mixer 1 comprising a gas and liquid fuel mixing pipe 15 arranged at the ends of a gas fuel supply pipe 11 and a liquid fuel supply pipe 13 so as to mix the fuels supplied from the supply pipes, wherein the gas and liquid fuel mixing pipe 15 has outlet holes and a fuel filter 17 is spaced from the mixing pipe 15 to filter off large particles from the mixed fuel, which then passes through a mixed fuel supply pipe 19 to the engine.

Clearly, in any such case where a fuel additive is introduced into the combustion chamber by way of the air intake, or even by being injected separately from the primary liquid fuel, more about which is said below in connection with further prior art examples, there is provided no teaching that the primary and secondary fuels, or liquid and gaseous fuels, are sufficiently mixed together prior to the injection and combustion events.

Turning now to the introduction of a fuel additive such as propane or hydrogen in the fuel stream, specifically, U.S. Pat. No. 6,845,608 to Klenk et al. teaches a method for operating an internal combustion engine in which at least two different fuels are simultaneously supplied to at least one combustion chamber of the internal combustion engine. More specifically, Klenk discloses the injection of hydrogen along with diesel fuel or gasoline through a common injector primarily for the purpose of emissions reduction, just as for most of the “fuel fractioning” prior art discussed above. Klenk teaches that the quantitative ratio of bi-fuel may be modified, or the percentage at which gasoline or diesel fuel is combined with hydrogen, with the hydrogen proportion being reduced with increasing operating temperature.

Similarly, U.S. Pat. No. 6,427,660 to Yang teaches a compression ignition internal combustion engine wherein a compressed combustible gas such as CNG (compressed natural gas) is used to bring or push the liquid fuel into the combustion chamber. At full engine loads the diesel fuel mass is to be less than five percent (5%) of the fuel mixture (CNG/diesel fuel). The ratio between diesel fuel and CNG will increase as the load on the engine decreases. The pressure of the CNG is kept between fifteen and forty five bars (15-45 bars or 218-653 psi)—preferably between fifteen and thirty bars (15-30 bars or 218-435 psi). The pressure of the diesel (liquid fuel) is always greater than the CNG (combustible gas) pressure, such that in at least one mode of operation the initial injection of CNG is retarded to reduce the homogeneity of the fuel within the combustion chamber, resulting in a stratified fuel distribution, which Yang suggests will promote a faster burn. Even where CNG and diesel are “mixed” pre-injection, there is no teaching or suggestion regarding the sufficiency or homogeneity of mixing, Yang even indicating that the two fuels burn separately in the combustion chamber, “the diesel fuel burn[ing] first by auto ignition and then the high temperature flame ignit[ing] the CNG.”

It is thus clear from such prior art as Klenk and Yang that there is shown only liquid and gaseous fuels essentially being co-injected without any means for sufficiently mixing the additive and the base fuel prior to injection, Yang even teaching that upon injection within the combustion chamber the fuels are not to be homogeneously mixed, but instead be stratified or burn separately, the CNG or compressed air additive simply serving to push the diesel fuel into the combustion chamber and, in the case of CNG, add additional energy value at the same time.

Other approaches in the art of bringing together multiple fuels as a common stream even ahead of injection yet involve further disadvantageous features and still without providing a desirable means to substantially homogeneously mix particularly liquid and gaseous fuels and maintain such homogeneity prior to injection. For example, U.S. Pat. No. 6,513,505 to Watanabe et al. teaches a system wherein fuel components such as diesel or light oil and an additive such as water, carbon dioxide, hydrogen, and hydrocarbon such as alcohol, methane and ethane can be mixed upstream of the fuel injection system, but wherein at least the additive must be at all times kept in its supercritical state, which is generally defined as being at a temperature and pressure above its thermodynamic critical point. To maintain such a supercritical state of the fuel additive, Watanabe teaches keeping the pressure “higher than the vaporizing (liquefying) [or critical] pressure of the additional fluid” in the fuel line all the way from the additive tank 9 to the pressurizing pump 6 and then heating the composition within the common rail 4 to a temperature above the additive's critical temperature—as such, Watanabe aims to keep the temperature of the fuel composition below the critical temperature of the additive before the fuel gets to the common rail and then above the additive's critical temperature once it is in the common rail. To do so introduces a number of complexities and attendant costs to the Watanabe system. Moreover, maintaining and dealing with these finely balanced physical fuel properties presents further challenges within the injection system, and the common rail 4, specifically. The vertically oriented common rail 4 in Watanabe is expressly configured not only to maintain specific temperatures and pressures but also to allow, as when the engine is off, for separation of the additional fluid, namely the gaseous fuel such as natural gas or methane, from the primary liquid fuel such as diesel, with the diesel occupying the bottom space of the common rail so as to be injected first until the common rail warms up, the additional fluid returns to its supercritical state, and the two fuel components then re-mix to some extent until “finally the two layers in the common rail 4 would disappear.” Therefore, it is clear that Watanabe introduces relatively costly and complex features in its “fuel feeding device” in an effort to maintain the additional fluid in a supercritical or liquid state.

Similarly, in a recently issued U.S. Pat. No. 7,488,357 to Tavlarides et al., there is taught a composition of diesel, biodiesel or blended fuel (“DF”) with exhaust gas (“EG”) mixtures or with liquid CO₂. The composition is in a liquid state near the supercritical region or a supercritical fluid mixture such that it quasi-instantaneously diffuses into the compressed and hot air as a single and homogeneous supercritical phase upon injection in a combustion chamber. Suitable temperatures and pressures are greater than about 300° C. and 100 bar (1,450 psi), and the mole fraction of EG or CO₂ (X_{EG} or X_{CO}_{₂}) in DF is in the range of 0.0 to 0.9. In a combustion process context, the composition is injected into a combustion chamber under supercritical conditions. The content of EG or CO₂ in DF can be controlled as a function of engine operating parameters such as rpm and load. Per Tavlarides, delivery of the DF-EG or DF-CO₂ composition into the combustion chamber as a homogeneous isotropic single-phase composition provides a significant increase in engine efficiency. Combustion process and fuel system embodiments of the invention provide an improved composition process with reduced formation of particulate matter (“PM”), aldehydes, polyaromatic hydrocarbons (“PAHs”), CO, NOx, and SOx. As with the Watanabe system, the Tavlarides system thus relies on increased temperatures and other system features to maintain the liquid fuel mixture in its supercritical state, adding cost and complexity to the engine's fuel system.

In U.S. Pat. No. 6,235,067 to Ahern et al., there is provided yet another “supercritical” scheme, here in which hydrocarbon fuel is nanopartitioned into nanometric fuel regions each having a diameter less than about 1,000 angstroms (0.1 micron) and either before or after the nanopartitioning the fuel is introduced into a combustion chamber. In the combustion chamber, a shock wave excitation of at least about 50,000 psi and with an excitation rise time of less than about 100 nanoseconds is applied to the fuel. Per Ahern, a fuel partitioned into such nanometric quantum confinement regions enables a quantum mechanical condition in which translational energy modes of the fuel are amplified, whereby the average energy of the translational energy mode levels is higher than it would be for a macro-sized, unpartitioned fuel. As claimed by Ahem, the process generally includes (a) forming a supercritical fuel-water mixture and (b) emitting the supercritical fuel-water mixture from a nozzle, whereby the temperature and pressure of the supercritical fuel-water mixture is reduced at a rate that causes hydrocarbon fuel of the supercritical fuel-water mixture to precipitate, thereby forming the nanopartitioned combustible liquid hydrocarbon fuel-water mixture. Thus, the fuel mixture taught by Ahern again entails not only a supercritical fuel mixture but here added equipment and extremely high-pressure shock waves within the combustion chamber to substantially instantaneously partition the fuel just before combustion. Or, put another way, just as for the general prior art approach discussed above of physically increasing the injection pressures and decreasing the nozzle diameters in order to decrease fuel droplet size with the intention of improving combustion, the Ahern approach also entails only mechanically acting on the fuel from the outside so as to break the droplets into smaller sizes rather than acting on the fuel from the inside by simply including and sufficiently dispersing an atomizing agent within the fuel itself pre-injection so as to aid in post-injection atomization.

In yet another category of prior art multi-fuel systems involving “on board” fuel mixing of some kind, there is taught a reverse approach where the gaseous fuel component such as propane becomes the primary combustible fuel and the liquid fuel such as diesel is a secondary ignition or combustion catalyst. For example, International Publication No. WO 2008/141390 to Martin discloses an injection system for a high vapor pressure liquid fuel such as liquefied petroleum gas (i.e., LPG or propane) that “keeps the fuel liquid at all expected operating temperatures” by use of a high pressure pump capable of at least 2.5 MPa pressures (363 psi). The fuel can be injected directly into the cylinder or into the inlet manifold of an engine via axial or bottom feed injectors and also could be mixed with a low vapor pressure fuel (e.g. diesel) to be injected similarly. Therefore, like Watanabe and others, Martin also teaches the desirability of maintaining all fuel constituents at all times as liquids, and thus maintaining relatively high system pressures, to facilitate mixing and other processing of the fuel before and during injection.

In U.S. Patent Application Publication No. US 2008/0022965 to Bysveen et al., there is taught a compression ignition internal combustion engine that operates using a methane-based fuel and again diesel or the like as an “ignition initiator.” Just as with Watanabe and Miller, Bysveen teaches that the “[g]as fuel is pressurized or liquefied and mixed with [the diesel fuel],” here off-board of the engine or vehicle, and then “[t]he pre-mixed fuel 3 is fed into a storage vessel 4 which maintains the fuel in a pressurized or liquid state.” In an alternative embodiment of Bysveen, “the injector 206 is arranged to receive the two fuel components and to introduce them simultaneously into the combustion chamber.” Here, much like Klenk, for example, “[t]he two components are mixed in the injector immediately before injection into [the] combustion chamber ensuring a uniform dispersion of ignition initiator in the pressurized or liquefied gas.” Accordingly, there is no fuel re-pressurization or other means to promote or achieve homogeneity of the fuel mixture in Bysveen, Klenk and other such systems, whereby only common rail rather than direct or mechanical injection may be employed, otherwise there may be pump cavitations, and, in the case of Bysveen, additional hardware in the form of specifically-engineered hydraulic injectors is still needed to insure that the liquid-gaseous fuel mixture is adequately injected (that is, that excess vapor formation that could lead to vapor lock is mitigated). Also like Klenk, Holder and others, Bysveen's primary aim is again emissions reduction rather than improved fuel efficiency.

Referring briefly to one further PCT patent application, analogous to Bysveen,

International Publication No. WO 2008/036999 to Fisher teaches a dual fuel system and assembly where liquid LPG and diesel are mixed and then distributed via the common rail to the combustion chambers. With the preferred embodiment of the dual fuel system, Fisher asserts that only minor changes are required to the diesel engine without altering the manufacturers' specifications. According to Fisher, the resultant combustion of the liquid fuel mixture provides cleaner emissions and relatively cheaper vehicle operational costs due to essentially the use of a less expensive fuel, not a result of greater efficiency. Fisher teaches that the liquid fuel mixture is “preferably pumped to a common rail under high pressure so that the liquid fuel mixture remains in a liquid state.” Liquefied gas such as propane, natural gas or compressed natural gas, or LPG at pressures of about 150 psi and pressurized diesel fuel at a pressure of approximately 100 psi form the liquid fuel mixture, with the ratio of LPG to diesel varying from 50:50 to 90:10; more preferably the ratio of LPG to diesel is approximately 70:30. It follows that just as for Watanabe, Bysveen, Miller and others, Fisher also teaches that the liquid and gaseous fuels are to be in liquid state, as by being under sufficient pressure, at all points in the mixing and delivery process within the disclosed dual-fuel system and so is common rail dependent. And as with others, Fisher would appear to again be only concerned with emissions reduction.

As suggested in one alternative embodiment in the Bysveen reference mentioned above, there is yet another category of prior art fuel compositions that involve fuel formation “off board” of the engine or vehicle, as would be typical of formulations developed by fuel companies themselves. For example, U.S. Pat. No. 6,302,929 to Gunnerman teaches an aqueous fuel having at least two phases for an internal combustion engine with 20-80 vol. % water, carbonaceous fuel, 2 to less than 20 vol. % alcohol, about 0.3 to 1 vol. % of a nonionic emulsifier, and which may contain up to about 0.1 vol. % of a fuel lubricity enhancer, and up to about 0.03 vol. % of an additive to resist phase separation at elevated temperatures. The fuel has an external water phase and is substantially nonflammable outside the engine. Also disclosed is a method of producing the fuel which includes mixing the carbonaceous fuel and emulsifier together prior to mixing with water and the other components. In U.S. Patent Application Publication No. US 2007/0294938 to Jukkula et al. there is disclosed a fuel composition for diesel engines, essentially a bio-diesel formulation, that comprises 0.1-99% by weight of a component or a mixture of components produced from biological raw material originating from plants and/or animals and/or fish. The fuel composition comprises 0-20% of components containing oxygen. Both components are mixed with diesel components based on crude oil and/or fractions from a Fischer-Tropsch process. U.S. Pat. No. 7,208,022 to Corkwell et al. teaches a fuel composition for use in an internal combustion engine containing (a) a diesel fuel, (b) ethanol, (c) a surfactant, and optionally (d) a combustion improver, which provides lubricity to the engine and reduces exhaust emissions. More particularly, the diesel fuel is present at 55 to 99% by weight, the ethanol is present at 0.5 to 25% by weight, the surfactant is present at 0.3 to 7% by weight, and the combustion improver is present at 0.005 to 10% by weight. The diesel fuel comprises a middle distillate fuel, a Fischer-Tropsch fuel, a biodiesel fuel, or mixtures thereof, and the combustion improver comprises an inorganic nitrate salt, a hydroxylamine compound, an organic nitro compound, a compound having at least one strained ring group containing 3 to 5 ring atoms, or a mixture thereof. And by way of still further example, in U.S. Pat. No. 6,860,909 to Berlowitz et al. there is disclosed a blend with oxygen or an oxygen containing gas useful as a diesel fuel, as well as a method for its production, comprising a high quality Fischer-Tropsch derived distillate boiling in the range of a diesel fuel blended with a cracked stock boiling in the range of a diesel fuel wherein the final blend contains 10-35 wt. % aromatics and 1-20 wt. % polyaromatics and produces low regulated emissions levels. Hence, the prior art “off board” alternative diesel formulations with various additives for stability, lubricity, and reduced emissions as summarized above are generally directed to compositions that do not include a gaseous fuel component and otherwise do not boast any appreciable boost in thermal efficiency, atomization, or combustion.

Thus, the prior art as summarized above includes various systems and fuels by which primarily diesel engines can be converted to operate in a “dual-fuel” or “multi-fuel” mode either by fractioning the liquid fuel (Hilton, Pinotti, Kemmler, Holder, and Glenz), by adding another fuel constituent to the fuel stream (Klenk, Yang and Watanabe) or the air intake (Funk and Bai), by formulating a fuel composition even “off board” to suit particular objectives (Gunnerman, Jukkula, Corkwell and Berlowitz), or by effectively reversing the fuels and injecting a small amount of diesel into the combustion chamber as a catalyst or, in the words of Bysveen, an “ignition initiator,” sometimes known as a “pilot injection,” which ignites or combusts an alternative fuel such as natural gas, propane or hydrogen that was introduced into the combustion chamber through the air intake or directly into the chamber separately from or mixed under pressure with the diesel (Martin, Bysveen, and Fisher). Certainly, in any such manner, a percentage of the diesel is replaced by such alternative fuels in the combustion event, resulting in lower exhaust emissions, especially particulate matter. This may also reduce fuel costs if the alternative fuels happen to be cheaper than diesel, though not necessarily reducing overall fuel consumption or actually improving fuel efficiency. Some of the more recent approaches to multi-fuel injection as highlighted above do go so far as to suggest that such alternative fuels be mixed with the diesel fuel at some point upstream, prior to the injection event, but these other references teach that (i) diesel remains a secondary fuel or “ignition initiator” in a small proportion relative to the alternative fuel, (ii) that specific physical states of the fuel components, such as supercritical or liquefication through sufficiently high pressures and/or temperatures, be maintained at all times in order for the fuels to be satisfactorily mixed and co-injected (see Watanabe, Tavlarides, and Ahern, and also Ishikiriyama, Hibino, and Avery below), and/or (iii) otherwise provide no teaching of a pre-injection substantially homogeneously mixed fuel composition so as to improve the atomizing effect on the diesel, bio-diesel, gasoline or other primary fuel component of the mixture by the uniform dispersion therethrough of the gaseous, or lower boiling point, fuel component.

Other prior art generally relating to the field of fuels and of efficiency and/or emissions improvement in internal combustion engines includes the following:

Japanese Patent No. 57135251 to Kinichi et al. teaches that air is injected from an inlet pipe 7 into a fuel leaving a feed pump 2. Since the mixing of air bubbles with the fuel is not sufficient, the fuel is agitated by means of a mixer 6, and a large number of pulverized air bubbles are uniformly distributed. Thus, the fuel is introduced into an injection pump 3 in this state. Since the injection pump 3 compresses the fuel at a high pressure of 200 atm or more, air bubbles are dissolved or pulverized and turned substantially into a liquid state. When this high pressure fuel is injected into a combustion chamber 5 from an injection nozzle 4, dissolved air is converted into air bubbles generated from the inner part of the atomized air. The atomized air is further mixed, and liquid drops are broken and further pulverized. Accordingly, the combustion is improved and fuel cost is decreased.

U.S. Pat. No. 4,373,493 to Welsh teaches a method and apparatus for utilizing both a liquid fuel and a gaseous fuel with a minimum change in a standard internal combustion engine. The gaseous and liquid fuels are fed from separate fuel supplies with the flow of fuels being controlled in response to engine load so that at engine idle only gaseous fuel is supplied and combusted by the engine and both gaseous and liquid fuels are supplied and combusted when the engine is operating under load conditions.

U.S. Pat. No. 5,207,204 to Kawachi et al. teaches an engine having a combustion chamber and a fuel injection valve for directly injecting a fuel into the combustion chamber. An assist air supplying apparatus supplies assist air to atomize the fuel injected by the fuel injection valve. Assist air supply pressure is controlled so that a given pressure difference is secured between the assist air supply pressure and pressure in the combustion chamber. The assist air, therefore, is supplied under proper pressure for an entire period of fuel injection, to adequately micronize the injected fuel and improve combustion efficiency.

U.S. Pat. No. 5,291,869 to Bennett teaches a fuel supply system for providing liquefied petroleum gas (“LPG”) fuel in a liquid state to the intake manifold of an internal combustion engine, including a fuel supply assembly and a fuel injecting mechanism. The fuel supply assembly includes a fuel rail assembly containing both supply and return channels. The fuel injecting mechanism is in fluid communication with the supply and return channels of the fuel rail assembly. Injected LPG is maintained liquid through refrigeration both along the fuel rail assembly and within the fuel injecting mechanism. Return fuel in both the fuel rail assembly and the fuel injecting mechanism is used to effectively cool the supply fuel to a liquid state prior to injection into the intake manifold of the engine.

U.S. Pat. No. 5,679,236 to Poschl teaches that a fuel mixture combusting virtually free of pollutants and, in addition, requiring only very small quantities of combustible hydrocarbons is produced by introducing liquid fuel, low-nitrogen air and water into a chamber (9) provided with at least one ultrasonic oscillator (7); by decomposing the fuel introduced and at least partially decomposing the water by cavitation; by dispersing the water and the air in the decomposed fuel; and by at least partially electrolytically decomposing the water. The proportion of water fed into the chamber (9) amounts to approximately up to 95% by volume of the fuel quantity. The liquid fuel is an oil, preferably a biological oil, and the air is dissolved in the liquid and water portion of the fuel mixture and characterized in mol ratio of oil:oxygen as 1:5 and carbon:oxygen as at least 1:8. The liquid fuel may be an alcohol and the mol ratio of alcohol:oxygen is at least 1:5. The fuel mixture has a foam-like consistency, is very easily combustible and can be stored for a longer time.

U.S. Pat. No. 5,730,367 to Pace teaches a fuel injector for an engine that includes a fuel volume having an air inlet port having a porous membrane. The membrane is permeable to air and impermeable to fuel whereby air inlet to the fuel volume forms a two-phase air bubble/fuel dispersion within the fuel volume. The pore size of each porous member is to provide sufficiently small air bubbles in the fuel volume so that the bubbles will not rise in the fuel or will rise only very slowly and at a rate that will not affect or substantially affect the mass flow of the two-phase air bubble/fuel dispersion through the injector orifice. Pace teaches that a pore size of 40 microns or less provides sufficiently small bubbles as to consistently enable a controlled mass of the air bubble/fuel dispersion through the injector orifice upon opening the needle valve. The porous members will provide a desired bubble size and substantially uniform distribution of bubbles into the fuel volume within the injector. To obtain the appropriate mass of bubbles in the fuel injector after selection of the proper pore size, Pace teaches that the mass flow of bubbles can be changed by changing the pressure differential across the porous membrane. Upon actuation of the needle valve of the injector, this two-phase air bubble/fuel dispersion flows through the orifice into the engine whereby improved atomization, burn and fuel economy with resultant reduction in emissions are provided.

U.S. Pat. No. 5,816,224 to Welsh et al. teaches a system for storing, handling, and controlling the delivery of a gaseous fuel to internal combustion engine powered devices adapted to run simultaneously on both a liquid fuel and a gaseous fuel. The invention provides a control system having a float controlled solenoid for ensuring that a consistent supply of dry gas is delivered to the engine. The invention uses the sensors and computer of the existing electronic fuel delivery system of the device to adjust the amount of liquid fuel delivery to compensate for the amount of gaseous fuel injection. The invention provides a gaseous fuel control system for a dual fuel device which is integrated and compact, and which preferably includes a fuel fill connection for the gaseous fuel. The invention also provides a horizontal fuel reservoir comprised of end interconnected parallel conduits and, preferably, includes two separate compartments and a pressure relief system for permitting expansion into a relief compartment from a main compartment. It also provides horizontal and vertical interchangeable reservoirs with expansion properties filled by weight.

U.S. Pat. No. 6,213,104 to Ishikiriyama teaches that the state of a liquid fuel such as diesel fuel is made a supercritical state by raising the pressure and the temperature of the fuel above the critical pressure and temperature. Then, the fuel is injected from the fuel injection valve into the combustion chamber of the engine in the supercritical state. When the fuel in the supercritical state is injected into the combustion chamber of the engine, it forms an extremely fine uniform mist in the entire combustion chamber. Therefore, the combustion in the engine is largely improved.

U.S. Pat. No. 6,584,780 to Hibino et al. teaches a system that stores densely dissolved methane-base gas and supplies gas of a predetermined composition. A container 10 stores methane-base gas dissolved in hydrocarbon solvent and supplies it to means for adjusting the composition, through which an object of regulated contents is obtained. Preferably, the means for adjusting the composition is means for maintaining the tank in a supercritical state, or piping 48 for extracting substances at a predetermined ratio from the gas phase 12 and liquid phase 16 in the container.

International PCT Patent Application Publication No. WO 2006/126341 to Kuroki et al. is directed to improving the mixability of liquid hydrocarbon fuel and hydrogen gas and reducing the number of parts required for fuel supply means that supply the two types of fuel. Disclosed is a hydrogen-fueled internal combustion engine that uses liquid hydrocarbon fuel and hydrogen gas as fuel. The hydrogen-fueled internal combustion engine comprises a fuel injection device for injecting hydrocarbon fuel; fuel supply means for supplying hydrocarbon fuel to the fuel injection device; and a microbubble generation device for generating microbubbles of hydrogen gas and mixing the generated microbubbles of hydrogen gas into liquid hydrocarbon fuel in the fuel supply means. The hydrogen gas microbubbles are supplied, for instance, to a fuel supply path (second fuel supply path) and fuel tank, which constitute the fuel supply means.

What is still needed and has been heretofore unavailable is a relatively simple, readily-available, and cost-effective improved fuel composition through which efficiency gains of on the order of ten to one hundred percent (10-100%) or more can be achieved in otherwise conventional internal combustion engines. The present invention meets this need and provides further related advantages as described in the following disclosure.

### DISCLOSURE OF INVENTION

Aspects of the present invention teach certain benefits in formation and use which give rise to the exemplary advantages described below.

In a first aspect of the present invention, dispersion of at least one gaseous fuel within at least one liquid fuel before introduction of the resulting fuel composition to an injection system of the internal combustion engine is such that molecules of the liquid and gaseous fuels are substantially equidistant one from another, liquid from liquid and gas from gas, within a variance preferably of no more than one hundred percent (±100%), more preferably of no more than fifty percent (±50%), and most preferably of no more than twenty-five percent (±25%), whereby the fuel composition is substantially homogeneous before being introduced to the injection system such that upon injection the rapid expansion of the gaseous fuel dispersed within the liquid fuel promotes the atomization of the liquid fuel and thus improves combustion.

In a second aspect, the gaseous fuel has an effective solubility in the liquid fuel at twenty degrees Celsius and one atmosphere in the range of 0.0000001 g/kg to 0.0002 g/kg.

Other features and advantages of aspects of the present invention will become apparent from the following more detailed description, taken in conjunction with the accompanying drawings, which illustrate, by way of example, the principles of aspects of the invention.

### BRIEF DESCRIPTION OF DRAWINGS

The accompanying drawings illustrate aspects of the present invention. In such drawings:

FIG. 1 is a schematic showing the formation of a first exemplary fuel composition according to aspects of the present invention within an illustrative fuel system; and

FIG. 2 is a schematic showing the formation of a second exemplary fuel composition according to aspects of the present invention within an illustrative fuel system.

### MODES FOR CARRYING OUT THE INVENTION

The above described disclosure illustrates aspects of the invention in at least one of its exemplary embodiments, which are further defined in detail in the following modes.

As a threshold matter, it is noted that the term “composition,” as in “fuel composition,” as used throughout is to be understood in its broadest sense as any union of parts or components to create a unified whole. Such a composition may be (1) a mixture, in which case two or more different materials are combined without a chemical reaction or bond occurring, or (2) a compound wherein the materials do have a chemical reaction, in which case the materials come together through a chemical union in definite proportion by weight, or even something in between depending on the particular fuels that make up the composition (i.e., where part of the components in the fuel composition react and part of them do not and so are only mixed). Furthermore, it is to be understood that the word “fuel” as used throughout the present application encompasses any combustible substance or any substance that aids in, enhances or otherwise affects combustion in some way. A “liquid fuel” is thus any “fuel” that is in the liquid state at atmospheric conditions, or at normal temperature and pressure (“NTP”), which is generally twenty degrees Celsius (20° C.) and one atmosphere. Moreover, a “gaseous fuel” is to be understood as any such “fuel” substance that is in the gaseous state at NTP conditions, including air or other inert gases, irrespective of the phases or states such a gaseous fuel may move through or be in at any particular point in the fuel system, injector, or combustion chamber, as will be appreciated from the more detailed explanation of aspects of the present invention set forth further below.

Generally, aspects of the present invention involve a liquid-gaseous fuel composition that is formed at some point measurably before the injection event and is maintained in a substantially homogeneous or steady state up to and through the injection event. That is, the fuel composition of the present invention is characterized in that the at least one gaseous fuel component is sufficiently dispersed or saturated within the at least one liquid fuel component or reacted with the liquid fuel component pre-injection such that atomization of the liquid fuel component and thus its combustion when introduced into the combustion chamber is greatly enhanced due primarily to the rapid expansion of the gaseous fuel component. While a variety of fuel compositions in terms of the liquid and gaseous fuel components are described herein, particularly diesel based fuels, it will be appreciated that the invention is not so limited and that other liquid fuel components such as gasoline or other hydrocarbons may be employed without departing from the spirit and scope of the invention. In that regard, it is noted in the exemplary context of hydrocarbon-based liquid fuels that such fuels generally encompass any compositions wherein a hydrocarbon, or a mixture of hydrocarbons, constitutes at least fifty percent (50%) of the normally liquid fuel, a hydrocarbon being generally defined as an organic compound consisting essentially of carbon and hydrogen. Again, any liquid fuels now known or later developed may be employed in the present fuel composition invention without departing from its spirit and scope. Moreover, while the exemplary fuel compositions are described in connection with a mixture rather than a chemical compound, such that the “steady state” pre-injection condition of the fuel composition is essentially a homogeneous or equilibrium phase, those skilled in the art will appreciate that, depending on the fuel constituents and the temperature, pressure, and other such variables at work, a chemical reaction may be set off instead and a resulting chemical compound formed that is then injected in such state and on that basis again results in more complete atomization of the fuel and more efficient combustion. Essentially, then, a fundamental principle at work in the present invention, regardless of the specific fuel components and how they unite (mechanically and/or chemically), is that the greater the uniformity or distribution of the gaseous component within the liquid component, the greater the atomization of the fuel composition upon injection and hence the more efficient the burn, which in turn also reduces unwanted emissions.

As further context for the fuel composition of the present invention, it will be appreciated that the resulting homogeneity of a mixture is a function of at least the following four variables: (1) time; (2) agitation; (3) pressure; and (4) temperature (acronym “TAPT”), each such variable ultimately being dictated by the system or hardware in which the fuel composition is formed and/or used. These TAPT variables are interdependent, such that generally as one of the variables increases, one or more of the others may be decreased to essentially achieve the same result. For example, the longer the components are allowed to mix or saturate, the less pressure that would be needed to arrive at the same end result in terms of the degree of homogeneity of the mixture. Or, as another example, the more that the mixture is agitated, the sooner it will reach homogeneity or equilibrium all else being equal. With regards to agitation, specifically, as by flowing, shaking, stirring, or mixing, it will be appreciated that another way of looking at this variable is “area.” That is, the more a mixture is agitated, the more surface-to-surface contact there would be between the constituents, which again further enhances mixing and homogeneity. Thus, taking a page from the “carbonation” process and understanding how a gas effectively dissolves in a liquid (through bubble dispersion and bubble size reduction), it is known that, all else being equal, the higher the pressure or the lower the temperature, the more gas is dissolved in the liquid to the point of maximum saturation for a given pressure, with agitation affecting the rate at which equilibrium is reached.

In a bit more detail, those skilled in the art will appreciate that while absolute pressure and temperature have an effect on maximum saturation, or the maximum amount of gas that can enter the liquid, the properties of both the gas and the liquid dictate what that maximum amount is at a given pressure and temperature. This “state function” is typically expressed as solubility or solubility factor and is a physical property of materials that relates to their chemical structure, which in turn can be measured or calculated using the mass transfer equation. Solubility “look up” values for common gases at particular temperatures and pressures are typically based on water as the solvent and so would be different for diesel or other hydrocarbon liquid fuels, which are complex liquids often made up of hundreds of compounds. But based on “solubility in water” values for gaseous fuels that may be employed according to aspects of the present invention, relative solubility can be expressed and understood as it relates to the resulting fuel composition. In Table 1 below there are shown solubility values for various gases in water at 20° C. and 1 atmosphere.

TABLE 1

| Substance | Solubility (g/kg)¹ |
|---|---|
| Air | 0.023 |
| Carbon Dioxide (CO₂) | 1.7 |
| Ethane (C₂H₆) | 0.06 |
| Ethylene (C₂H₄) | 0.25 |
| Hydrogen (H₂) | 0.002 |
| Methane (CH₄) | 0.023 |
| Nitrogen (N₂) | 0.018 |
| Oxygen (O₂) | 0.045 |
| Propane (C₃H₈) | 0.07 |

¹Data taken from The Engineering Toolbox, www.engineeringtoolbox.com/gases-solubility-water-d_1148.html.

Another related aspect is the nucleation size of the gaseous bubbles, or essentially the smallest bubbles that a gas can form going into or out of solution, or at the point of dissolving completely into a liquid, which is also a physical property of a gas again relating to its chemical make-up, and particularly its surface tension, though is once again likely dependent on pressure. In addition to the external pressure acting on the gas as it is introduced to the liquid, as the bubbles get smaller, the internal pressure of each bubble increases due to the surface tension squeezing the bubble harder. This will continue until a particular gas bubble gets to a critical size at a certain pressure and temperature and then collapses and disappears, the gas at that point being not only dispersed within the liquid but actually completely dissolved in the liquid, such that when the external pressure is removed, as when the fuel composition undergoes a pressure drop upon entering the combustion chamber, the gas will have to come back out of solution, a process that generally requires more time than a gas bubble simply expanding after being squeezed to some point short of its nucleation size. Assuming equilibrium between the gas phase of the bubble and the partial pressure of gas (i.e., gas tension or internal pressure) in the liquid, there is thus a critical size that the particular gas bubble must have in order not to collapse due to the force of surface tension at a given hydrostatic pressure. Increasing the hydrostatic or system pressure will decrease the critical size, ultimately causing the complete collapse of the bubble. Nucleation thresholds for specific gases in water as a function of pressure are shown in Table 2 below.

TABLE 2

| | Nucleation threshold |
|---|---|
| Substance | (psi ± 75 psi)² |
| Hydrogen (H₂) | 3,820 |
| Methane (C₂H₄) | 1,760 |
| Nitrogen (N₂) | 2,940 |
| Oxygen (O₂) | 2,440 |

²Data taken from Encyclopedia of Surface and Colloidal Science, by Taylor & Francis, pg. 4778.

Bubble nucleation from dissolved gases in liquid often occurs in the supersaturation state developed by the sudden decompression of the liquid equilibrated with gas at high pressure, which is essentially what happens when the liquid-gaseous fuel composition passes from the relatively high pressure injector into the relatively low pressure combustion chamber. Clearly, this is a highly dynamic and substantially instantaneous transition (the entire combustion cycle only lasting on the order of 2 to 10 milliseconds). Accordingly, another way of looking at the spontaneous nucleation threshold, or the conditions below which the bubbles will form or come back out of solution, is as the minimum gas supersaturation that produces sudden, massive, effervescent bubble formation throughout the liquid. Therefore, according to Table 2 above, it will be appreciated that when injection pressures go to the order of 2,000 psi or higher for methane (or natural gas), 3,000 psi or higher for oxygen or nitrogen, or 4,000 psi or higher for hydrogen, it is expected that a supersaturated liquid-gaseous fuel composition of diesel and such a gaseous fuel (assuming solubility in diesel on the same order of magnitude as water) will exhibit massive spontaneous bubble formation as the gas comes out of solution due to the pressure drop seen in the combustion chamber upon injection (supersaturated solutions essentially contain more dissolved gas than would otherwise be possible due to elevated system pressures, such as carbonated water, for example). It again follows that an aspect of the present invention relates to sufficiently mixing and pressurizing the liquid-gaseous fuel mixture pre-injection to take advantage of the spontaneous nucleation or atomization effects that likely occur in the combustion chamber as a result. Moreover, because spontaneous nucleation generally requires more time than a gas bubble simply expanding after being squeezed to some point short of its nucleation size, it will be appreciated that the combustion reaction can be slowed slightly, by perhaps a few milliseconds, so that there is a relatively slower pressure rise instead of instantaneous in the combustion chamber, thereby having a relatively cooler and more controlled burn, which in turn further reduces emissions and also causes the engine to run quieter. When the gas molecule is in its dissolved state it is closely packed by liquid molecules, such that advantageously, as will be appreciated from the below discussion of specific exemplary embodiments of fuel compositions according to aspects of the present invention, not much gaseous additive relative to the liquid is required to see these nucleation and atomization benefits. Under spontaneous nucleation theory alone, taking nitrogen, for example, tests have revealed that at a solution pressure of 200 atmospheres (about 3,000 psi), the concentration is only 0.1 M, or one gas molecule per 550 water molecules. Encyclopedia of Surface and Colloidal Science, by Taylor & Francis, pg. 4779. Even with such low concentration, the gas affects the structure of the liquid sufficiently to rupture it. With the gas then substantially homogenously distributed throughout the liquid, it will be appreciated that the effect of even such a small amount of gas on the surrounding liquid will be significant.

Regarding the actual typical injection event, it is noted that to the extent the gaseous component of a liquid-gaseous fuel mixture is sufficiently dispersed within the liquid component, or the degree to which the mixture has reached equilibrium, the greater the atomization effect the gaseous component will have on the liquid component. Typically, the pressure drop a fuel sees when passing out of the injector and into the combustion chamber in a direct injection context is at least half or fifty percent (50%), such as from at least 600 psi in the injector delivery line down to on the order of 300 psi in the combustion chamber. As is known, the pressures in the injector delivery lines or common rails of diesel engines are often on the order of 2,000 to 25,000 psi, with the industry trying to take these pressures even higher as indicated above in an effort to improve atomization of the liquid diesel fuel (reduce droplet size) by simply pushing the fuel through smaller and smaller injector openings (nozzle diameters) and higher and higher pressure differentials. Even for gasoline direct injection systems, the injection pressures are often on the order of 750 to 1,500 psi so as to still provide at least a fifty percent (50%) pressure drop upon injection. According to aspects of the fuel composition of the present invention, even better atomization and combustion can be achieved without the cost and complexity of high pressures, modified nozzle designs, and other such measures taken as part of prior art fuel delivery systems and engine designs in eking out improvements in fuel economy and/or emissions.

One additional mechanical or chemical effect on the fuel composition, particularly under the conditions within the combustion chamber, may be the formation of free radicals by some gaseous fuels such as hydrogen. Free radicals are atoms, molecules, or ions with unpaired electrons on an otherwise open shell configuration. These unpaired electrons are usually highly reactive, so radicals are likely to take part in chemical reactions, most often attacking double bonds in adjacent compounds. This, in fact, is how combustion occurs generally, set off by an extremely reactive spin-paired (singlet) state of oxygen that causes radical chain reactions to form hydroperoxide radical (HOO—), which reacts further into hydroperoxides that break up into hydroxide radicals. The presence of additional hydrogen or oxygen, for example, can thus have a further effect on the liquid fuel beyond the mechanical nucleation and atomization effects discussed above by potentially initiating free radical chain reactions within the combustion chamber—in fact, the only kind of reactions fast enough to occur within a typical combustion cycle. And if the gaseous fuel additive that helps set off such a free radical chain reaction is itself sufficiently or substantially homogenously dispersed within the liquid fuel, the additive will set off reactions throughout the combustion chamber substantially simultaneously in at least some of the surrounding hydrocarbons that have much higher fuel value, thereby furthering the combustion effect and hence the efficiency with which the liquid fuel burns. A measure of a substance's ability to form free radicals is the heat of formation of the remaining compound when, for example, a hydrogen molecule is broken off. Therefore, the lower the heat of formation or energy of the resulting compound, the more likely that free radicals may be formed from the initial substance, such as CH₃ and a H— radical being formed from methane (CH₄). Preferably, then, in connection with the formation of free radicals, the gaseous fuel is selected having a heat of formation (ΔH_{f}) of less than −20 kcal/mol.

These natural phenomena of solubility, supersaturation, nucleation, and free radical formation all have an impact on the formation and/or performance of fuel compositions according to aspects of the present invention, as will be appreciated from the discussion that follows further below regarding particular exemplary embodiments.

Regarding the fuel composition of the present invention, again, the composition is generally described in a number of exemplary embodiments as a substantially homogeneous liquid-gaseous fuel mixture. Homogeneity of the fuel, or the degree to which the at least one gaseous component is dispersed in the at least one liquid component, can be quantified in a number of ways. Employing high-powered microscopes, Raman spectroscopy, infrared (“IR”) or near infrared (“NIR”) spectroscopy, turbidity systems, or other such technologies, the extent or degree of mixing can be measured as the relative physical distances between liquid fuel droplets or molecules as spaced apart by the gaseous molecules or bubbles, or vice versa. In this way, taking as an example a relatively low pressure pre-injection state of the mixture, the more equidistant the liquid component molecules, the more evenly dispersed the gaseous component molecules or bubbles therein. As such, in exemplary embodiments of the fuel composition of the present invention, the liquid or gaseous component molecules or droplets are substantially equidistant one from another (liquid from liquid or gaseous from gaseous) within a variance, or deviation from the mean as a percentage of the mean, of preferably of no more than one hundred percent (±100%), more preferably of no more than fifty percent (±50%), and most preferably of no more than twenty-five percent (±25%). More particularly, in employing an NIR spectrometer, for example, a quantitative measure of homogeneity may be determined by calculating the standard deviation of the distribution of pixel intensities in the partial least squares (“PLS”) score images or still-shots of the fuel composition, the spatial distribution of the components being based on the variation or contrast in pixel intensity, which is due to the NIR spectral contribution to each pixel. In such NM method, the pixel intensities distribution as a measure of the distance between any two molecules or droplets of a liquid-gaseous fuel mixture of the present invention is preferably within three standard deviations of the mean distance, more preferably within two standard deviations of the mean, and most preferably within one standard deviation of the mean, assuming for simplicity a substantially normal distribution. As another related means of quantifying the degree of homogeneity of the fuel mixture, the actual liquid fuel droplet size can be measured at the point of atomization. Preferably the droplets are of a diameter less than 250 microns, and more preferably less than 10 microns, which again is a function of and proportional to each gaseous fuel component and the degree to which it is dispersed within the liquid fuel. Finally, the homogeneity of the fuel mixture can be quantified or understood in conjunction with the time for saturation of the gaseous fuel component within the liquid fuel component, or the “soak time” or the time allowed for the liquid and gaseous fuel components to, in the exemplary embodiment of a mixture, reach a point of saturation or equilibrium—preferably at least 10 milliseconds from the time the components are mixed to the time the mixture is delivered to the injector pump or fuel gallery/common rail, more preferably at least 1 second, and most preferably at least 5 seconds. In any such manner, it will thus be appreciated that the degree of homogeneity, however measured, may be achieved by pre-pressurization of the fuel mixture, circulation of the fuel mixture, and/or agitation or slowing of the fuel mixture.

Turning now to the exemplary components making up the liquid-gaseous fuel composition and the ratios by which they may be combined, there are a number of such compositions illustrative of aspects of the present invention. However, once more, it will be appreciated by those skilled in the art that though particular fuel compositions are thus disclosed herein, the invention is not so limited but instead may be practiced employing a variety of such liquid and gaseous components now known or later developed in a range of ratios, whether fixed or dynamic, depending on the context. Preferably, the fuel composition will be mixed at a fixed ratio, which greatly simplifies the system and has been shown to provide the desired results, but again this is not necessary. It will be appreciated that numerous means now known or later developed for moving and metering fuels, whether liquid or gas, and for controlling such a process may be employed without departing from the spirit and scope of the invention, such as pumps, sensors and valves, and control devices of various kinds. In one example, the tank of a particular gaseous fuel may be under such pressure that a pump is not needed to move the fuel from its tank to the mixing point. Or, rather than a tank, the fuel supply may instead be comprised of an opening or inlet communicating with the atmosphere so as to effectively “breathe” air into the fuel system for mixing with the diesel and/or or other fuel(s) according to aspects of the present invention, as explained in more detail below.

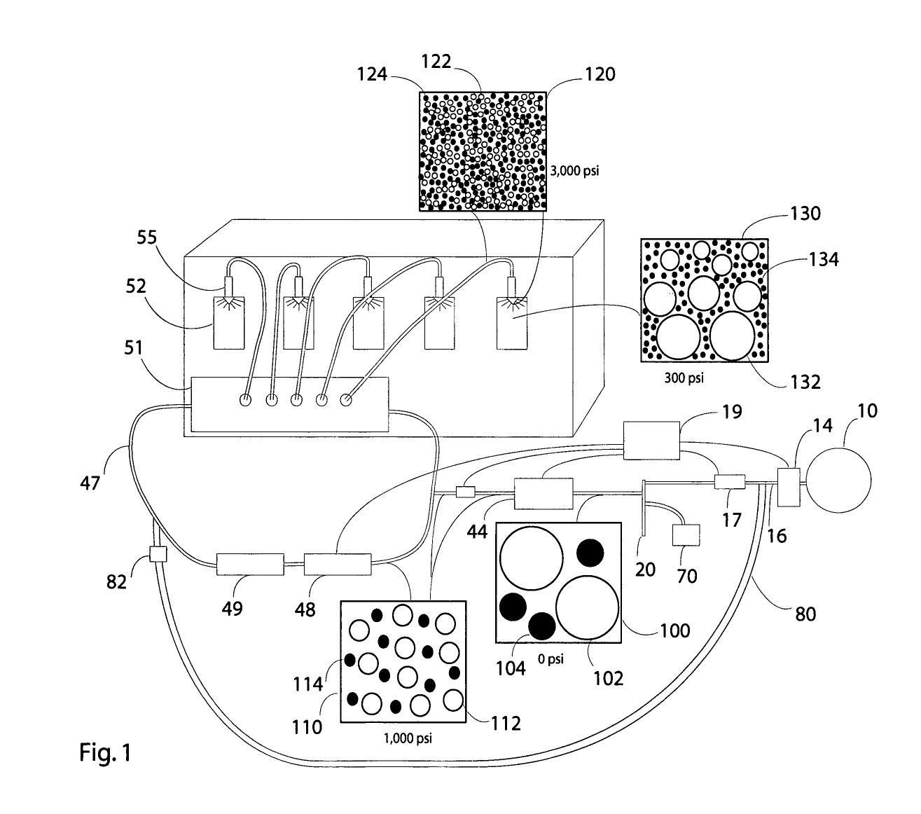

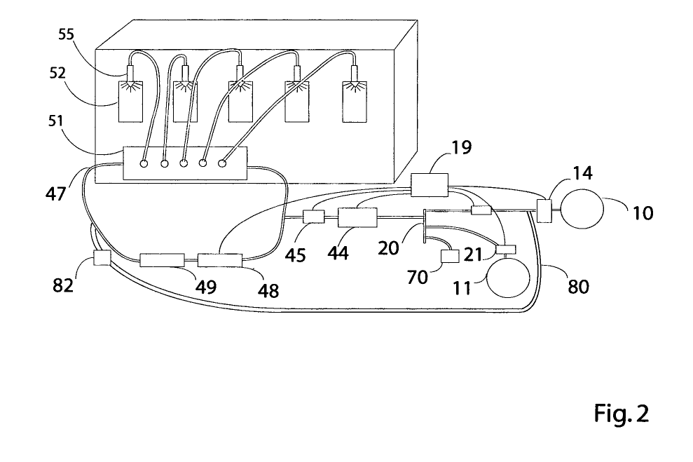

In a first exemplary embodiment, then, it is expressly disclosed that the “gaseous fuel” that may be employed in a liquid-gaseous fuel composition according to aspects of the present invention is simply air. In such an embodiment, rather than a second tank or other fuel source within the fuel delivery system, there would simply be an air intake 70 (see FIGS. 1 and 2), or more generally an inlet or opening in the fuel system through which air may be drawn. In the exemplary embodiment, the air intake 70 is a filtered opening to the pump 44 by way of the mixing manifold 20, though it will be appreciated that the air may be stored in a compressed air cylinder or the like or be routed to a compressor or pump ahead of the mixing point so as to be pressurized before being introduced to the liquid fuel. A variety of air intake configurations and locations, such as a hose to the front of the vehicle, are possible without departing from the spirit and scope of the invention. It should be appreciated that the air intake 70 employed in connection with on-board formation of a fuel composition according to aspects of the present invention is not the same as the air intake to the engine or the like, though that same air intake could be used with a splitter to divert some of the air into the fuel system rather than to the engine directly in the conventional fashion. In any case, it is to be understood that the air being drawn into the fuel system according to aspects of the present invention is, in fact, to be mixed with the other liquid and/or gaseous fuels of the particular fuel composition embodiment for injection directly into the combustion chamber(s) of the engine, the advantages of which will be better understood in the context of the below explanations. More generally, though the air is described as being atmospheric or ambient, it will be appreciated that this does not necessitate a particular or exact temperature and pressure of the air, as such will vary depending on a number of factors, including the location relative to sea level, the weather, the type and location of the air intake or other air source or compressor, the operation of the engine, and other such factors. Therefore, it is to be understood that according to aspects of the present invention, air from the atmosphere, at whatever temperature and pressure it happens to be, is drawn into or introduced to the fuel system for mixing with one or more other fuels to form a substantially homogeneous liquid-gaseous fuel composition before being introduced to the injection system.

In more detail, referring first to FIG. 1, there is shown in diagram form an illustrative multi-fuel co-injection system wherein, in the exemplary embodiment, diesel and air are co-mixed as described above, the schematic including representations of the liquid and gaseous fuels as they move through the system and so are taken to different pressures as indicated. More specifically, as shown in FIG. 1, air at substantially or nominally ambient conditions is drawn in through the intake 70 and is mixed at the manifold 20 with the diesel fuel supplied from the tank 10 by way of a pump 14 and combination flow control and valve 17. The inflow of air may be controlled by a regulator, pressure switch, valve, or other such means, with the proportion of air by volume relative to the diesel fuel varying depending on the context. Preferably the ratio of the fuels is less than fifty percent (50%) by liquid volume air, more preferably less than twenty-five percent (25%), and most preferably less than ten percent (10%). In the exemplary embodiment, at the first stage both the diesel fuel and the air are at substantially ambient temperature and pressure, indicated nominally as 0 psi in the schematic first stage 100, wherein the air molecules are represented by circles 102 and the diesel fuel droplets are represented by solid dots 104. The diesel-air fuel mixture is then brought up to roughly 1,000 psi by the high pressure positive displacement pump 44, as represented by the schematic second stage 110, whereby the gas bubbles of the air, represented by circles 112, are squeezed to a first size that is smaller than the bubbles at ambient conditions as represented by circles 102 at the first stage 100. Meanwhile, the compression of the air actually serves to fragment or begin the dispersion or reduced droplet size of the diesel fuel, as represented by the slightly smaller and more numerous solid dots 114 as compared to the dots 104 at the ambient first stage 100. It is noted that the fuel mixture as represented in this second stage 110 is substantially homogeneous throughout the fuel system downstream of the high pressure positive displacement pump 44, or essentially throughout the circulation loop 47, as indicated schematically. It will be appreciated that in the illustrative system the substantially continuous circulation of the fuel in the circulation loop 47 further disperses the diesel fuel and homogenizes the fuel mix downstream of the pump 44, by providing both agitation and simply time for the liquid and gaseous components of the fuel composition, here diesel and air, to move toward equilibrium. Next, the diesel-air mixture is supplied from the circulation loop 47 to the injector pump 51 and further pressurized to an injection pressure on the order of 3,000 psi, as represented by the schematic third stage 120, thereby further squeezing the air bubbles as represented by circles 122 and further compressing the fuel mixture for better dispersion and reduction of droplet size of the diesel fuel as represented by dots 124. Finally, the diesel-air fuel mixture is injected through standard injectors 55 into the combustion chambers 52, where combustion pressures are typically on the order of 300 psi as indicated in the schematic fourth stage 130, wherein the air bubbles represented by circles 132 rapidly expand, leading to tremendous atomization and dispersion of the diesel fuel within the combustion chamber 52 as represented by dots 134. It will be appreciated by those skilled in the art that the fuel system and engine operating pressures may vary significantly depending on a variety of factors relating to the engine design and fuel(s) selected, such that the above-indicated pressures and the schematically shown fuel composition in various stages of FIG. 1 are gross generalizations to be understood as merely exemplary and the present invention is not limited thereto. More generally, it will also be appreciated that a variety of hardware or system components and configurations are possible beyond the high pressure positive displacement pump and circulation loop of the illustrative system and that such systems, whether now known or later developed, may be substituted and are beyond the scope of the present invention, which is directed to the novel substantially homogeneous liquid-gaseous fuel composition itself. It follows that the schematic representations of the fuel moving through various stages of the fuel supply system and combustion process of the engine are merely for illustration of the principles of the invention.

There are a number of advantages of true co-mixing of air with one or more other fuels and co-injection of such a fuel mixture via the injector, rather than only mixing air with the fuel in the combustion chamber as in a typical diesel engine, a typical gasoline engine (spark ignition engine), cross-over diesel and gasoline engines (so-called “DiesOtto” engines), and homogeneous charge compression ignition engines (“HCCI” engines). With all such prior art approaches, a typical air intake, such as through an air intake manifold or the like, is employed in introducing air into an engine's combustion chamber to then be mixed with the injected fuel for combustion. Bringing the air charge in by this conventional means provides effectively no opportunity for the air to be mixed into the fuel pre-ignition, let alone substantially homogenously, and thus is virtually incapable of having any real effect on atomization of the liquid fuel by bubble formation (nucleation), free radical formation, or otherwise. By comparison, according to aspects of the present invention, air and/or some other gaseous fuel is pre-mixed with a liquid fuel within the fuel supply system, not just introduced separately into the combustion chamber through a conventional air intake or even mixed right at the point of injection. While having air in the fuel line or system has previously been thought of as disadvantageous, and actually taught away from, with a system for homogenizing the liquid-gaseous fuel mixture such as the illustrative high pressure positive displacement pump 44 downstream of the manifold or mixing point 20 capable of compressing such a liquid-gas mixture, the gaseous fuel component and/or air of the fuel mixture is actually sufficiently compressed, or the gas bubbles sufficiently reduced in size as shown and described above in connection with FIG. 1, such that the gaseous fuel's compressive “springy” aspect has been reduced to behave more like a liquid. Based on nucleation and surface tension effects, it is noted that some gases are more prone to compressibility or this “springy” aspect than others, nitrogen forming particularly robust bubbles and thereby having a relatively strong tendency toward reforming such bubbles (nucleation) when coming back out of solution upon a pressure drop—nitrogen, of course, comprising approximately eighty percent (80%) of ambient dry air. The system may then maintain pre-injection such compressed, substantially homogeneous fuel mixture through the illustrative circulation loop 47. And then further mixing and compression of the liquid-gas fuel mix by way of the injector pump 51 increases the liquid aspect of the mixture delivered via the injector 55 into the combustion chamber 52 even more, depending on the particular fuels in the co-mixture, the system pressures and temperatures, and other factors. In this regard, it is noted that some gases may, in fact, be in a supercritical state pre-injection, which potentially adds still further effects post-injection in the combustion chamber. Taking air as the exemplary gaseous fuel, it is noted that its critical pressure is 573 psi and critical temperature is −140° C., such that at any point in the system where the air is essentially above 573 psi, since the fuel will never be below the critical temperature, the air will be a supercritical fluid. Those skilled in the art will appreciate that supercritical fluids have further interesting and potentially “tunable” properties since close to the critical point small changes in pressure or temperature result in large changes in density, viscosity, and other mechanical properties of the fluid. Since the pressure in at least the injector lines or common rail is expected to be above 573 psi, it follows that at the point of injection, the air is supercritical. But immediately after injection, when the liquid-gaseous fuel composition enters the nominally 300 psi combustion chamber, the air would move out of the supercritical region and back to gas, thereby changing its physical properties and having a further effect on the liquid fuel as it changes state. In addition, approximating the nucleation size of the air bubbles as those of nitrogen, it will be appreciated based on Table 2 above that if the pre-injection pressure is above approximately 3,000 psi, the air bubbles will also undergo nucleation or reformation out of solution upon injection, further atomizing the fuel.

In any event, those skilled in the art will appreciate that substantially or roughly homogeneous mixing of air with a liquid fuel such as diesel within the fuel line or system, by whatever means, so as to be co-injected, or passed as a single fuel stream via a single fuel path or passage through a single or common orifice or opening, greatly enhances the atomization of the fuel upon injection by a number of mechanical and/or chemical means. That is, rather than only being mixed with the injected fuel in the combustion chamber essentially as the combustion event is happening (as in a typical diesel or gasoline engine) or introduced separately from the injected fuel through either a double-injector or a single injector-multiple orifice configuration as is also known in the art, either way involving two or more separate fuel streams, with the air molecules dispersed throughout the injected fuel as in the fuel composition according to aspects of the present invention, upon the rapid expansion of the air molecules at injection, when the fuel mixture goes from roughly 3,000 psi to roughly 300 psi in the example, the fuel is rapidly and violently dispersed within the combustion chamber for an even and efficient combustion. And the added presence of the air actually pre-mixed with the fuel, above and beyond any air typically present in the combustion chamber, provides still more oxygen for the combustion and renders the fuel mixture aerated, whereby the air expansion effectively increases the compression ratio for better combustion while at the same time yielding a cooling or adiabatic effect, the injected air being substantially at the engine block temperature. Therefore, gaseous fuel and/or air being substantially uniformly mixed with liquid fuel prior to injection expands rapidly as in a phase transformation by changing its liquid characteristics into gaseous upon injection to atomize and disperse the liquid fuel, enabling a more effective combustion along with an increased compression ratio. And, unlike prior art approaches, this may be accomplished without any retrofitting or replacement of the actual injection system and internal components within the engine. These and other advantageous aspects of the fuel composition of the present invention will be readily appreciated by those skilled in the art.

By way of further illustration of aspects of the present invention, referring now to FIG. 2, there is shown an alternative fuel supply system again relating to a diesel-type internal combustion engine with a multi-fuel supply, here consisting of a tank 10 containing petroleum diesel fuel, a filtered air intake 70 for introduction of ambient air into the fuel system as above-described, and now a tank 11 containing a gaseous second fuel to be mixed with the diesel and air. In the exemplary alternative embodiment, the second fuel is propane, though it will be appreciated once more that any gaseous fuel as that term is used herein now known or later developed or discovered may be employed without departing from the spirit and scope of the invention. And though two or three fuels total have been shown in the exemplary embodiments as being co-mixed and co-injected, it will be further appreciated that any number of fuels may be co-mixed and co-injected according to aspects of the present invention without departing from its spirit and scope. Referring still to FIG. 2, a liquid fuel such as diesel, bio-diesel, vegetable oil, or gasoline is passed from a first tank 10 to a mixing manifold 20 and a gaseous fuel such as propane or any other gaseous fuel now known or later developed, such as natural gas, generated methane, or hydrogen, is passed from a second tank 11 also to the manifold 20. In addition, in the alternative exemplary embodiment, air is again drawn through the air intake 70 into the manifold 20 for mixing with the one or more other fuels, here diesel and propane. Preferably the ratio of the gaseous fuels is less than twenty-five percent (25%) by liquid volume each, more preferably less than twelve percent (12%), and most preferably less than five percent (5%), with the diesel fuel making up at least fifty percent (50%) by liquid volume of the total fuel composition. With the addition of propane, it is noted that there is thus included in the fuel composition a further gaseous fuel that is generally three times as soluble as air, as shown in Table 1 above, and also adds fuel value to the composition. Once more, it is to be understood that the invention is not limited to the exemplary embodiments shown and described herein or the illustrative systems within which such a fuel composition is formed and used, which embodiments are merely for illustration of the principles and aspects of the fuel composition of the present invention.

In sum, in a first exemplary embodiment of the substantially homogeneous liquid-gaseous fuel composition according to aspects of the present invention, liquid and/or gaseous fuels are mixed with air prior to being relatively highly pressurized, circulated, and/or otherwise sufficiently mixed and then injected as a single fuel mixture through a single fuel line or flow path and a standard single-inlet injector, thereby producing better atomization of the fuel and thus more efficient and effective combustion within an otherwise conventional internal combustion engine.

Taking as a second exemplary embodiment the substantially homogeneous mixture of diesel as the liquid fuel component and propane as the gaseous fuel component, here without air, preferably the ratio of the fuels is less than fifty percent (50%) by liquid volume propane, more preferably less than twenty-five percent (25%), and most preferably less than ten percent (10%). Or, put another way, in the alternative embodiment the propane is preferably added to the diesel fuel at a ratio of approximately two pounds of propane per gallon of diesel (2 lb/gal), more preferably at a ratio of approximately one pound of propane per gallon of diesel (1 lb/gal), and most preferably at a ratio of approximately a quarter pound of propane per gallon of diesel (0.25 lb/gal). With such a diesel-propane fuel composition, the effective fuel economy is substantially increased. This is due once more to the relatively homogeneous dispersion of the propane within the diesel as described above using whatever mechanical means are appropriate and the resulting rapid expansion of the propane within the liquid diesel when the composition experiences a relatively large pressure drop upon injection into the combustion chamber. Relatedly, due to propane's relatively low boiling point of approximately 125 psi at atmospheric temperature, the propane may additionally go through a phase transformation from liquid back into gas due to the higher temperatures in the combustion chamber, thereby going through a violent expansion of approximately 250:1 and further atomizing the diesel fuel. Moreover, the added carbon content or increased hydrogen as a result of an added hydrocarbon rich fuel constituent such as propane again adds fuel value and thus further enhances combustion.

In a further alternative exemplary embodiment wherein the fuel composition of the present invention consists of liquid diesel fuel and gaseous hydrogen, in one exemplary system the hydrogen is supplied from a pressurized tank and regulated to approximately 200-1,000 psi and a flow rate of approximately 500 cc/min gaseous to be mixed directly into the diesel fuel stream. Once again, those skilled in the art will appreciate that other infeed pressures and flow rates are possible depending on the fuel constituents and the engine size and type and other context without departing from the spirit and scope of the present invention. In the exemplary embodiment, the effective liquid-to-liquid volumetric fuel ratio of this particular diesel-hydrogen fuel composition is then approximately two percent (2%) hydrogen by volume. In so doing, the consumption of the fuel composition is significantly reduced for the same power output and the effective mileage of the vehicle is thereby increased.

In actual testing, a diesel-hydrogen fuel composition according to aspects of the present invention was mixed on board and utilized in a 2009 Volkswagen Jetta TDI (turbocharged 2.0-liter four-cylinder engine having a compression ratio of 16.5:1 and 140 horsepower; and a six-speed Tiptronic automatic transmission) having a retrofitted fuel delivery system beyond the scope of the present invention through which the hydrogen was infed at about 200 psi. The mileage test data from an independent laboratory are presented and incorporated herein by reference. The Jetta TDI standard mileage, diesel fuel only, resulted in thirty four point six miles per gallon (34.6 mpg) where the vehicle was run without the fuel enhancement system being activated at approximately fifty miles per hour (50 mph) under various loading conditions to simulate highway driving. With the Jetta TDI with the fuel enhancement system activated for a fuel composition that measured at ninety seven point eight percent by volume (97.8% vol) diesel and two point two percent by volume (2.2% vol) hydrogen, the resulting average effective mileage was found to be eighty seven point one miles per gallon (87.1 mpg), or a two hundred fifty one point seven percent (251.7%) improvement over the vehicle baseline (“diesel only” operation) of thirty four point six miles per gallon (34.6 mpg). Further tests in which the hydrogen was infed at about 375 psi again revealed significant fuel savings of the liquid diesel on the order of at least 30%. Similar tests were run with carbon dioxide through which no appreciable liquid fuel consumption reductions were realized, whereas with equally inert air or nitrogen improvements in fuel economy were seen. It is therefore noted that in addition to any fuel value or free radical formation effects derived from hydrogen, the solubility of each gas within the liquid fuel, diesel in the exemplary embodiment, and these fuels' mechanical or chemical interactions more generally, also has an impact on which gaseous additives provide the greatest benefits. Specifically, though each of these gases—air, nitrogen, hydrogen, and carbon dioxide—are likely in a supercritical state pre-injection so as to effectively go through a phase transformation in the combustion chamber (the critical pressures being 573 psi for air, 514 psi for nitrogen, 294 psi for hydrogen, and 1,132 psi for carbon dioxide), and each is likely at a pressure within the combustion chamber well below the nucleation threshold pressure such that it would be expected that each gas would come back out of solution and thereby have a further atomization effect on that basis as well (see Table 2 above for at least oxygen, nitrogen, and hydrogen), it is observed that carbon dioxide, having a solubility in water of on the order of one hundred times (100×) that of air (nitrogen and oxygen) and on the order of one thousand times (1,000×) that of hydrogen, appears to be essentially too soluble so as to not readily come back out of solution and have an atomization effect on the liquid fuel. Therefore, as a general corollary, it is preferable to squeeze the gas bubbles as small as possible to promote homogeneity and atomization of the fuel composition upon injection, even past the point of nucleation, without being so highly dissolved that the bubbles are effectively inhibited from coming back out of solution and rapidly expanding. As such, it can be said that the preferred solubility of a gaseous fuel additive is between 0.001 g/kg and 1.5 g/kg in water as the solvent at 20° C. at one atmosphere. Based on such solubility range in water, the effective solubility range for gaseous fuel components according to aspects of the present invention may be calculated for solvents other than water (i.e., the liquid fuels) such as diesel and gasoline by multiplying the water solubility as shown in Table 1 by the mole fraction of the gaseous fuel additive according to the following formula:

C_{w}=the effective solubility=(Xₒ)(S)

where

S=the standard solubility of the gas at NTP in water

Xₒ=the mole fraction of the gas=(MFₓ)(MWₒ)/MWₓ

and where

MFₓ=the mass fraction of the gas

MWₒ=the molecular weight of the liquid

MWₓ=the molecular weight of the gas

Based on the foregoing formula and the proportion of gaseous fuel added to liquid fuel by mass or volume according to aspects of the present invention, assumed to be two percent by liquid volume on average, a range of effective solubility for the gaseous fuel generally within a hydrocarbon liquid fuel such as diesel or gasoline having molecular weights of approximately 230 g/mole and 100 g/mole, respectively, is roughly 0.0000001 to 0.0002 g/kg.

Accordingly, and more generally, there is disclosed in one exemplary embodiment herein a new and improved substantially homogeneous mixture of diesel and hydrogen wherein preferably the ratio of the fuels is less than twenty percent (20%) by volume hydrogen, more preferably less than ten percent (10%), and most preferably less than five percent (5%), based on hydrogen in liquid state. In any such relatively homogeneous liquid-gaseous fuel mixture, it will be appreciated that the viscosity of the mixture will be less than that of the liquid fuel alone at ambient conditions, here diesel (<4.6 cp (centipoise) or 4.6 mPa-s), which is achieved without heating the fuel as in prior art approaches. More notably, once again, due to the system and method by which the liquid and gaseous components are mixed pre-injection, here diesel and hydrogen, the resulting fuel composition is substantially uniform, or is a substantially homogeneous mixture, at the point of injection, thereby more completely atomizing and burning the fuel within the combustion chamber with the resulting extraordinary improvements in mileage as documented herein then being realized.

Regarding the system or hardware facilitating the mixing or compounding of such a substantially homogeneous liquid-gaseous fuel composition according to aspects of the present invention, as mentioned previously, pre-pressurization of the fuel composition and/or circulation of the fuel composition or the like are just examples of the means by which the requisite time, agitation, temperature and/or pressure (“TAPT”) within the fuel delivery system (before the fuel is delivered to the engine's injection system (injector pump or fuel gallery/common rail)) can be provided. Whatever the mechanical means, one common feature of the exemplary embodiments is that the compositions be formed “on board,” that is, as part of the operation of the vehicle in which the enhanced fuel and resulting enhanced internal combustion engine are operating, though it will be appreciated that formation of such a novel fuel composition may be accomplished “off board” as well, depending on the context. In the exemplary “on board” process through which fuel compositions according to aspects of the present invention are formed, as already discussed above, in a first aspect, the dwell or saturation time between the point at which the liquid and gaseous constituents are mixed and the point at which they are delivered to the injector pump or fuel gallery/common rail of the engine is to be at least 10 milliseconds, more preferably at least 1 second, and most preferably at least 5 seconds. The agitation of the fuel composition to further encourage a complete dispersion of the gaseous fuel within the liquid fuel may be expressed in terms of the surface area over which the components are able to interact and the gaseous component migrate and dissolve into the liquid component. In the exemplary embodiment, this is more completely expressed as a volume, or a surface area over a given length, and is preferably at least 10 in³, more preferably at least 20 in³, and most preferably at least 30 in³, it having been found that any such volumetric expansion within the fuel delivery system at or downstream of the mixing point and upstream of the injector pump or fuel gallery/common rail has the effect of further agitating and mixing the fuel composition and thus promoting homogeneity. Regarding the pressure in the fuel delivery system, it is preferably between approximately 100 psi and 2,000 psi (0.7 to 13.8 MPa), more preferably between approximately 140 psi and 1,500 psi (1.0 to 10.3 MPa), and most preferably between approximately 180 psi and 360 psi (1.2 to 2.5 MPa)—high enough to facilitate mixing and the composition being seen by the injector pump as a liquid but not so high as to require significant pressurization and thus parasitic losses in the system or be at supercritical conditions for many gaseous fuel additives, or otherwise introduce additional cost and complexity into the system. Finally, then, the temperature of the fuel composition at all times from the point of mixing the constituents to the point of delivery to the injector pump or fuel gallery/common rail is preferably between −200° C. and 350° C. (−320 to 662° F.), more preferably between −20° C. and 300° C. (−4 to 572° F.), and most preferably between 0° C. and 250° C. (32 to 482° F.)—it being preferable to keep the fuel relatively cool, once again, to facilitate mixing or saturation of the gaseous component within the liquid, which is generally taught away from in the art (prior art efforts in this context being directed to heating the fuel in fractioning or in attaining a supercritical state). It will be appreciated that cooling the fuel can be achieved in a number of ways, which are beyond the scope of the present invention, but more generally that there is neither taught nor expected that the fuel composition would be cooled to the point that the gaseous components of the composition would undergo a phase transformation to liquid particularly in the preferred operating ranges of pressure and temperature set forth above (for example, hydrogen turns liquid at approximately −253° C. at ambient pressure), with the exception of propane or other such relatively higher boiling point gaseous fuels (propane turns liquid at approximately −42° C. at ambient pressure). There is thus described herein a fuel composition that by its constituents has a relatively higher specific heat or a relatively higher resistance to heat absorption. In combination with the fuel circulation system and the adiabatic effects the gaseous component is going to have whenever it undergoes an expansion or a pressure drop, as when the fuel composition first enters the combustion chamber or unused fuel exits the common rail through a return line, the result is a fuel composition that is more prone to staying relatively cooler. In an exemplary embodiment of a fuel composition that is 99% diesel and 1% hydrogen by liquid volume, the specific heat is approximately 2.1 J/g° C. as compared to 2.0 J/g° C. for diesel fuel alone at ambient conditions. Again, this aspect of the fuel composition of the present invention promotes its tendency toward exothermic rather than endothermic reactions, or toward fuel cooling (the saturation process of the gas in the liquid also being an exothermic reaction). It will be appreciated that the uniformity of the fuel composition, or the degree to which the gaseous component is dispersed within the liquid, once more aids in the performance of the fuel—here the energy exchange effect. Relatedly, those skilled in the art will further appreciate that a fuel composition according to aspects of the present invention also has an anti-gelling effect. That is, a gaseous fuel such as hydrogen or air dispersed throughout the liquid diesel fuel effectively serves as an insulator forming boundary layers between the diesel fuel droplets, thereby preventing gelling of the fuel particularly in cold weather—another added benefit of the fuel composition of the present invention.

In terms of other possible liquid-gaseous fuel compositions, by way of further example, diesel, gasoline, or other liquid fuel may be combined in a variety of ways with one or more gaseous fuels such as natural gas, which includes compressed natural gas (CNG) and liquefied natural gas (LNG), methane, oxygen, hydrogen, nitrogen, ethylene, ethane, propane, or air to arrive at novel, substantially homogeneous fuel compositions according to aspects of the present invention. By way of further example, then, beyond those examples set forth above, clearly contemplated by the present invention are fuel compositions including but not limited to: diesel and natural gas; diesel and methane; diesel and ethylene; diesel and ethane; diesel and nitrogen; diesel, natural gas, and air; diesel, methane, and air; diesel, hydrogen, and air; diesel, ethylene, and air; diesel, ethane, and air; diesel, natural gas, and hydrogen; diesel, methane, and hydrogen;

diesel, ethylene, and hydrogen; diesel, ethane, and hydrogen; and diesel, propane, hydrogen, and air. Again, other liquid fuels such as gasoline may be substituted for the diesel fuel in the exemplary compositions or any others, as can be other gaseous fuels and various combinations of both the liquid and gaseous fuels, beyond those described, whereby other such substantially homogeneous fuel compositions are also within the scope of the present invention. It is noted particularly in the context of propane and another gaseous fuel such as hydrogen being together added to liquid diesel, that it is anticipated that the propane may facilitate infusion of the hydrogen or other gaseous fuel, or dispersion of the gaseous fuel within the diesel-propane hydrocarbon liquid fuel, as a function of the surface tension of propane versus that of hydrogen or some other gaseous fuel. Once more, it will be appreciated that a wide range of such liquid-gaseous fuel compositions having particular characteristics may be formed according to aspects of the present invention without departing from its spirit and scope.

The fuel compositions according to aspects of the present invention are thus characterized by liquid-gaseous mixtures or compounds wherein the constituents are sufficiently dispersed one within the other, and particularly the one or more gaseous components within the one or more liquid components, before being introduced to the injection system, and the injector pump or fuel gallery/common rail, specifically, so as to automatically and substantially atomize the liquid fuel(s) upon injection into the combustion chamber due to the rapid expansion of the gaseous fuel component(s) distributed throughout the liquid fuel. It will be appreciated that such an approach results in rupturing and fogging the fuel rather than spraying or even misting, and thus more complete combustion without the need for precisely engineered injector nozzles or extremely high injection pressures—there is thus disclosed herein a fuel composition that may be used in a common rail, but is not common rail dependent. It will be further appreciated that the gaseous fuel effectively automatically displaces the liquid fuel through the pre-pressurization and homogenization of the fuel composition as described herein such that a vehicle's fuel injection system does not have to be modified in any way to accept and utilize the fuel composition of the present invention.

It follows from the foregoing that fuel compositions according to aspects of the present invention provide a number of novel features and resulting advantages over the art. As set forth above, by substantially evenly dispersing at least one gaseous fuel component within a liquid fuel component pre-injection, a homogeneous burn or combustion of the liquid fuel is achieved. In the case of the infused diesel fuel composition, rather than tiny droplets burning from the outside like peeling an onion, the diesel droplets are atomized from the inside due to the presence of the gaseous component, effectively “rupturing” the fuel and exploding “the onion.” This again results in fogging the fuel within the combustion chamber and a much more complete combustion. The rapid expansion of the gaseous fuel component dispersed within the liquid fuel component of the fuel composition as it enters the combustion chamber, and particularly as it just passes the injector tip, actually serves to clean or purge the injectors, thereby leading to longer life and performance. The improved combustion of the fuel composition in turn reduces NOx and particulate emissions, for one, having simply reduced the total amount of fuel being burned and, thus, the amount of emissions (CO₂), and also having more completely burned the liquid fuel component that was injected. It will be further appreciated that the presence of gaseous fuel within the liquid fuel also enables an adiabatic cooling effect within the combustion chamber with improved thermal efficiency, which also helps with emissions. The end result is that for the same engine output (kW), use of a fuel composition according to aspects of the present invention yields a ten percent (10%) minimum increase in fuel efficiency (kW/gal).

In sum, those skilled in the art will appreciate that herein is disclosed a relatively simple, readily-available, and cost-effective improved fuel composition through which efficiency gains of on the order of ten to one hundred percent (10-100%) or more can be achieved in otherwise conventional internal combustion engines.

Accordingly, it will be appreciated by those skilled in the art that the present invention is not limited to any particular fuel composition, much less the particular exemplary embodiments shown and described, and that numerous such compositions are possible without departing from the spirit and scope of the invention. Rather, the scope of the invention is to be interpreted only in conjunction with the appended claims and it is made clear, here, that the inventor believes that the claimed subject matter is the invention.

What is claimed is:

1. A fuel composition for use in an internal combustion engine comprising at least one liquid fuel and at least one gaseous fuel, the gaseous fuel having an effective solubility in the liquid fuel at twenty degrees Celsius and one atmosphere in the range of 0.0000001 g/kg to 0.0002 g/kg, wherein dispersion of the gaseous fuel within the liquid fuel before introduction of the fuel composition to an injection system of the internal combustion engine is such that molecules of the liquid and gaseous fuels are substantially equidistant one from another, liquid from liquid and gas from gas, within a variance preferably of no more than one hundred percent (±100%), more preferably of no more than fifty percent (±50%), and most preferably of no more than twenty-five percent (±25%), whereby the fuel composition is substantially homogeneous before being introduced to the injection system such that upon injection the rapid expansion of the gaseous fuel dispersed within the liquid fuel promotes the atomization of the liquid fuel and thus improves combustion.

2. The fuel composition of claim 1 wherein the time between mixture of the gaseous fuel into the liquid fuel to form the fuel composition and introduction of the fuel composition to the injection system is preferably at least 10 milliseconds, more preferably at least 1 second, and most preferably at least 5 seconds, whereby homogeneity of the fuel composition before introduction to the injection system is further promoted.

3. The fuel composition of claim 2 wherein the fuel composition is formed within a volume that is preferably at least 10 in³, more preferably at least 20 in³, and most preferably at least 30 in³, whereby homogeneity of the fuel composition before introduction to the injection system is further promoted.

4. The fuel composition of claim 1 wherein the pressure within a fuel delivery system of the internal combustion engine between the point of mixture of the gaseous fuel into the liquid fuel to form the fuel composition and introduction of the fuel composition to the injection system is preferably between approximately 100 psi and 2,000 psi (0.7 to 13.8 MPa), more preferably between approximately 140 psi and 1,500 psi (1.0 to 10.3 MPa), and most preferably between approximately 180 psi and 360 psi (1.2 to 2.5 MPa).

5. The fuel composition of claim 4 wherein the fuel composition is in a supersaturated state before introduction to the injection system.

6. The fuel composition of claim 5 wherein the gaseous fuel is selected from the group consisting of methane and natural gas and the nominal injection pressure of the injection system is at least roughly 2,000 psi, whereby the gaseous fuel is pressurized beyond the nucleation threshold pressure.

7. The fuel composition of claim 5 wherein the gaseous fuel is selected from the group consisting of air, nitrogen, and oxygen and the nominal injection pressure of the injection system is at least roughly 3,000 psi, whereby the gaseous fuel is pressurized beyond the nucleation threshold pressure.

8. The fuel composition of claim 5 wherein the gaseous fuel is hydrogen and the nominal injection pressure of the injection system is at least roughly 4,000 psi, whereby the gaseous fuel is pressurized beyond the nucleation threshold pressure.

9. The fuel composition of claim 1 wherein the gaseous fuel is selected having a spontaneous nucleation threshold pressure beneath the nominal injection pressure of the injection system, whereby further atomization is achieved upon injection as the gaseous fuel comes out of solution and reforms.

10. The fuel composition of claim 1 wherein the temperature of the fuel composition at all points between mixture of the gaseous fuel into the liquid fuel to form the fuel composition and introduction of the fuel composition to an injection system of the internal combustion engine is preferably between −200° C. and 350° C. (−320 to 662° F.), more preferably between −20° C. and 300° C. (−4 to 572° F.), and most preferably between 0° C. and 250° C. (32 to 482° F.).

11. The fuel composition of claim 1 wherein the gaseous fuel has a heat of formation (ΔH_{f}) of less than −20 kcal/mol, whereby the gaseous fuel being substantially homogenously dispersed throughout the liquid fuel pre-injection has the capacity to set off free radical reactions throughout the combustion chamber substantially simultaneously in at least some of the surrounding liquid fuel having a higher fuel value so as to further the combustion effect.

12. The fuel composition of claim 1 wherein the gaseous fuel has a critical pressure (Cₚ) within 300 psi of the nominal combustion chamber pressure of 300 psi, whereby the gaseous fuel undergoes an effective phase transformation upon injection.

13. The fuel composition of claim 1 wherein the specific heat of the fuel composition at twenty degrees Celsius and one atmosphere is greater than roughly 2.1 J·kg/° C.

14. The fuel composition of claim 1 wherein:
the liquid fuel is diesel; and
the gaseous fuel is air, the air preferably mixed within the diesel such that the ratio of the fuels is less than fifty percent (50%) by liquid volume air, more preferably less than twenty-five percent (25%), and most preferably less than ten percent (10%).

15. The fuel composition of claim 1 wherein:
the liquid fuel is diesel;
the at least one gaseous fuel comprises a first gaseous fuel being propane and a second gaseous fuel being air, the propane and air preferably mixed within the diesel such that the ratio of the gaseous fuels to the liquid fuel is less than twenty-five percent (25%) by liquid volume each, more preferably less than twelve percent (12%), and most preferably less than five percent (5%).

16. The fuel composition of claim 1 wherein:
the liquid fuel is diesel; and
the gaseous fuel is selected from the group consisting of hydrogen and nitrogen, the gaseous fuel preferably mixed within the diesel such that the ratio of the fuels is less than twenty percent (20%) by volume gaseous fuel, more preferably less than ten percent (10%), and most preferably less than five percent (5%).

17. The fuel composition of claim 1 wherein:
the liquid fuel is diesel; and
the at least one gaseous fuel comprises a first gaseous fuel being propane and a second gaseous fuel being hydrogen, the propane and hydrogen preferably mixed within the diesel such that the ratio of the gaseous fuels to the liquid fuel is less than twenty-five percent (25%) by liquid volume each, more preferably less than twelve percent (12%), and most preferably less than five percent (5%).
